(19) United States
(12) Patent Application Publication
(10) Pub. No.: US 2005/0053091 A1
(43) Pub. Date: Mar. 10, 2005

(54) Method and infrastructure for minimizing compatibility issues among interacting components of different dialect versions

(75) Inventor: Man-Ho Lawrence Lee, Milpitas, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, LP, Houston, TX (US)

(21) Appl. No.: 10/655,161

(22) Filed: Sep. 4, 2003

(51) Int. Cl. H04J 3/16; H04J 3/12

(52) U.S. Cl. 370/466; 370/522

(57) ABSTRACT

A method and an infrastructure for minimizing compatibility issues among interacting components of different dialect versions. Such issues are associated with a plurality of versions of a dialect for communication in a system including a plurality of components that exchange a plurality of types of requests. Each request is formatted in accordance with one of the plurality of versions of the dialect and has a header carrying a type-version identifier indicating a corresponding type and version of the request. In the infrastructure, each component includes: an input port for receiving one of the requests; at least one handler supporting requests of a corresponding one of the plurality of types and versions; and switching logic to extract the type-version identifier carried by a received request for use in determining and invoking a selected handler. One or more of the following features also may be included: a data structure for use in managing handlers; incompatibility reporting logic for reporting receipt of incompatible data to a human operator; and a data structure for controlling sending of the data. The type-version identifier can be extended to accommodate further demand.

### BACKGROUND

In a wide variety of electronic systems, data must be exchanged between components of the systems in accordance with a pre-designed dialect. For example, in a network, components at distributed nodes of the network may exchange data over long distances in accordance with a protocol, which is one form of dialect. As another example, in a non-distributed (or local) electronic system, components in spatial proximity may exchange data in accordance with an interface, which is another form of dialect. Hereinafter, for simplicity, the term data refers to exchanged data formatted in accordance with a dialect.

Usually, data includes a header that has a fixed format, and a payload of a less restricted format. The header has information indicating the type, versioning, and other information specific to a dialect. For example, in a network transport protocol, a destination address may be included in the header to enhance the efficiency in processing the data. The format of the payload is specific to the type specified in the header, and the payload may contain the details of a request or a response.

The data exchanged by components includes requests, which are actions taken for communication in accordance with a dialect by a participating component. A request can give rise to a response, which can be considered to be a request of a specific type. In the context of an interface, a request is typically a function call, while a response is the reply to the call in the form of a call back function. Hereinafter, the term “request” is used interchangeably with the term “data.”

By definition, a fixed format of a header of data poses problems if there is a need for a header change. For example, a dialect must be modified to accommodate newer software or hardware features as they are introduced into a system. In such a case, the versioning information of the header may be used to identify a correct interpretation of the data.

Versioning is an aspect of a dialect that differentiates between various implementations, or versions, of a dialect. Different versions of a dialect may employ different types of requests. Versioning also refers to and includes logic for enforcing differentiation and compatibility among different versions. In general, versioning can be considered to be an attribute of a particular request in a dialect.

Excessive versioning information and processing thereof can introduce unnecessary overheads into components while insufficient versioning or incorrectly implemented versioning logic can cause incompatibility problems between versions during transition or migration. Hereinafter, the term “migration” refers to upgrading and/or modifying components.

In accordance with current dialect versioning systems, each component in a system is provided with a plurality of handlers, and, typically, each of the handlers is operative to process data formatted in accordance with different versions of the dialect. A handler operative to process data formatted in accordance with a particular version of the data is said to “support” that particular version. If a version specified in a header of data is not one of the versions supported by a particular handler, the data is flagged as incompatible with that particular handler and would not be processed.

In the context of existing protocols, a version verification process is typically preformed during a setup phase. In the context of an interface, a version verification process is typically performed upon the very first use of the interface. After verification of the version of a dialect, one component assumes another component to be compatible and capable of communicating in accordance with the dialect. Typically, this type of verification is used if the components can keep track of the versioning information of other components. For example, both a client and a server may be able to keep track of version information for each other so as to communicate in accordance with a connection oriented protocol. In other existing systems, version verification is not performed at the setup phase (e.g., a connection-less protocol is stateless). Instead, version checking may be done before data is processed using versioning information included in the header of the data.

In current systems that perform version verification processes, each of the handlers relies on dialect versioning information to process data correctly. In general, a handler has logic that differentiates between versions of a type of request. Typically, the logic contains versioning-sensitive code fragments that need versioning checking. Incorporation of the dialect versioning information into the logic is error prone and tedious because the logic is often implemented implicitly. Another problem is that an implementation bug that may arise in interpreting a protocol version may result in incorrect processing of the data, which is inherently neglected or otherwise has not been well thought of. In addition, implementation bugs can break implementation assumptions upon which different interacting components rely, and, as a consequence, catastrophic irrecoverable results can occur.

In addition, if incompatible versions co-exist in an environment and a dialect is stateless, handling logic must be implemented to prevent the incompatible versions from interacting with each other. If not enough care is taken in designing migration, some down-rift components may babble. Here, the term “babble” refers to attempting to transmit data with a volume or frequency that is not expected by the receiving node, causing the receiving node to abnormally increase its use of resources. Also, in some cases, a protocol cannot handle the incompatibility problem in the sense that such unexpected abnormal increase in resource usage is sufficiently significant that it creates qualitative difference in the behavior of the babbled node. For example, a buffer may not be large enough to hold all packets coming from a babbling component, causing the receiving node to drop compatible incoming requests in addition to incompatible requests.

Versioning is relatively simple if there aren't too many versions involved. However, versioning can become painstakingly tedious and error prone if there is a large number of versions and interacting components. Currently, non-standard approaches are used to solve this versioning problem. Each component needs to know about all previous versioning information and how to deal with implementation variants. Also, each component needs to understand how the other components deal with the versioning information in data sent by the component. Thus, in the context of current approaches, versioning control requires a large amount of versioning information. Hereinafter, the term “version control” refers to maintenance of various versions of a dialect supported by a system.

### SUMMARY

Briefly, a representative embodiment of the present invention provides a method and infrastructure for minimizing compatibility issues in a system having a plurality of components between which requests may be exchanged (including requests, responses and data) in accordance with a dialect. It is assumed that each request is one of a plurality of different types, and that each request is formatted in accordance with one of a plurality of different versions of the dialect. To enable two-way communication, at least one handler is installed at each of a first component and a second component, each of the handlers supporting a corresponding one of the types and versions of requests. The method includes a step of defining a plurality of type-version identifiers each indicating a corresponding one of a plurality of types and versions of requests.

The method also includes steps of: sending a request from the first component to the second component, where the sent request has a type-version identifier indicating a particular type and version of the sent request; and causing the second component to perform a series of steps in response to receiving the sent request. Upon receiving the sent request, the second component: extracts the type-version identifier of the sent request; uses the extracted type-version identifier to determine whether one of the handlers installed at the second component properly supports the particular type and version of the sent request; and if a proper one of the installed handlers supports the type and version of the sent request, uses the proper handler to process the sent request.

In one embodiment, the first component is provided with a first data structure for indicating whether or not the first component may send requests of the particular type and version to the second component. Before sending a request, the first component accesses the first data structure to determine whether requests of the particular type and version may be sent to the second component.

In another embodiment, at least one of the plurality of type-version identifiers is reserved for indicating a stop sending control request. A stop sending control request includes a first field carrying the reserved type version identifier, and a second field carrying a second type version identifier. In this embodiment, if none of the installed handlers at the second component properly supports the particular type and version of the sent request, the second component sends a stop sending control request to the first component to indicate that the first component should stop sending requests of the particular type and version to the second component. Upon receiving the stop sending control request, the first component updates the first data structure to indicate that the first component may not send requests of the particular type and version to the second component.

The request may carry the type-version identifier in a header field. The type-version identifiers may be extended by defining a sub-type-version identifier in the header field. The type-version identifier includes a reserved value that indicates the presence of the sub-type-version identifier in the header field. The type-version identifiers may be extended even further by extending the sub-type-version identifier by defining a sub-sub-type-version identifier in the header field. The sub-type-version identifier has a reserved value that indicates the presence of the sub-sub-type-version identifier in the header field. If needed, further extension can be performed in the same manner.

In an embodiment, the above described step of using the extracted type-version identifier to determine whether one of the handlers installed at the second component properly supports the particular type and version of request further is performed by using the extracted type-version identifier to index a second data structure. The second data structure includes a plurality of pointers, each pointer being associated with one of the plurality of type-version identifiers and pointing to a corresponding one of the handlers installed at the second component.

An unsupported-type-version handler may be installed at the second component. The unsupported-type-version handler may support requests carrying any one of a plurality of unsupported type-version identifiers, wherein the sent request carries one of the unsupported type-version identifiers. The unsupported-type-version handler may be invoked in response to the received unsupported type-version identifier without indexing the second data structure. In this embodiment, the second data structure need not store pointers for each of the unsupported type-version identifiers.

One advantage of the described system and method is that logic may be employed for processing a particular version of a request in each component which need not understand how the other components deal with the other types of requests and other versions of the same request type, and therefore, as long as the components follow a set of rules as defined here, a large amount of versioning logic is not required in individual request processing logic for enforcing versioning control. Therefore, implementation of different versions of a dialect separated from dialect versioning control is made possible so that the versioning infrastructure can provide a less error prone, more efficient, more extensible way of enforcing version control.

Another advantage in implementations of the described system and method is that a set of policies may be enforced on dialect designers to avoid incompatibility problems with minimal efforts. Finally, as no implicit assumption is made in request handler about versioning of a dialect, request processing code fragments inside a request handler need not be dependent on preceding versioning code fragment. This results in more readable and manageable code.

### BRIEF DESCRIPTION OF THE DRAWING

The accompanying drawings, which are incorporated in and constitute a part of this specification, illustrate several embodiments of the present extensible versioning infrastructure and together with the description, serve to explain the principles of the infrastructure and its operation. Whenever convenient, the same reference numbers will be used throughout the drawings to refer to the same or like elements.

FIG. 1A a block diagram of a system supporting an extensible versioning infrastructure facilitating the exchange of data between a plurality of components;

FIG. 1B is a block diagram of a first embodiment of the system of FIG. 1A wherein the system is a non-distributed system, and the dialect is an interface;

FIG. 1C is a block diagram of a second embodiment of the system of FIG. 1A wherein the system is a distributed system, and the dialect is a protocol;

FIG. 2A is a block diagram illustrating data formatted in accordance with a dialect of the extensible versioning infrastructure, the data including a header having a type-version identifier, and a body;

FIG. 2B is a block diagram showing an extended data format including fields reserved for a type-version identifier and sub-type-version identifier;

FIG. 2C is a block diagram showing another extended data format having an additional field for a sub-sub-type-version identifier;

FIG. 3 is a schematic diagram illustrating further details of a component operating in accordance with the present extensible versioning infrastructure;

FIGS. 4A and 4B are schematic block diagrams illustrating exemplary operation of the component shown in FIG. 3;

FIG. 5 is a tabulated block diagram illustrating data field structures of a plurality of different control requests;

FIG. 6 is a schematic block diagram illustrating elements of FIG. 3 configured to optimize use of memory;

FIG. 7 is a schematic block diagram illustrating an embodiment of the system of FIG. 1A, wherein each component exchanges data in accordance with a process that employs a data structure containing pointer array and send flag array; and

FIG. 8 is a flowchart illustrating a versioning control process for exchanging data of different types and versions between the components of the system of FIG. 7.

### DETAILED DESCRIPTION

To enable one of ordinary skill in the art to make and use the invention, the description of the invention is presented herein in the context of a patent application and its requirements. Although the invention will be described in accordance with the shown embodiments, one of ordinary skill in the art will readily recognize that there could be variations to the embodiments and those variations would be within the scope and spirit of the invention.

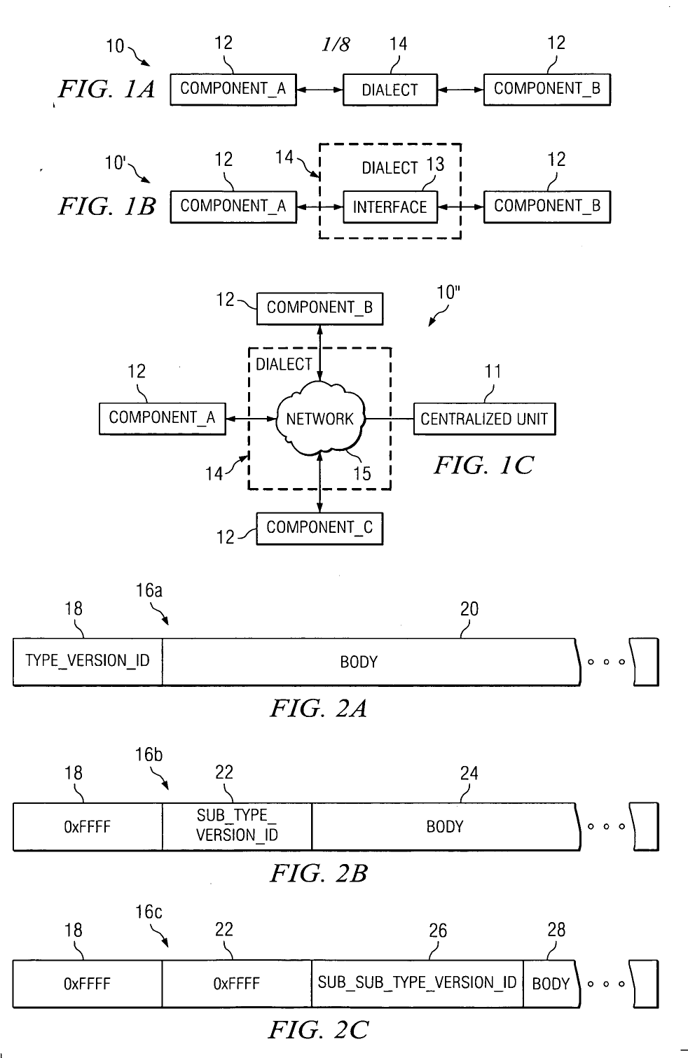

FIG. 1A shows a block diagram of a system 10 including a plurality of components 12 between which data may be exchanged, formatted in accordance with a pre-defined dialect 14. The component exchange data of various types, each data being formatted in accordance with an associated one of a plurality of different versions of the dialect 14. As explained below, the versioning infrastructure that is employed provides a less error prone, more efficient, more extensible way of controlling the different versions of the dialect 14.

One implementation of the system 10′ is a non-distributed system having local-components 12 in spatial proximity, as shown in FIG. 1B. In this implementation, the dialect 14 is an interface 13. In an alternative implementation, system 10″ is a distributed system having network-components 12 and a centralized unit 11 for managing the system 10″, as shown in FIG. 1C. In this instance, the components 12 exchange data over long distances, and the dialect 14 is implemented by a network protocol 15.

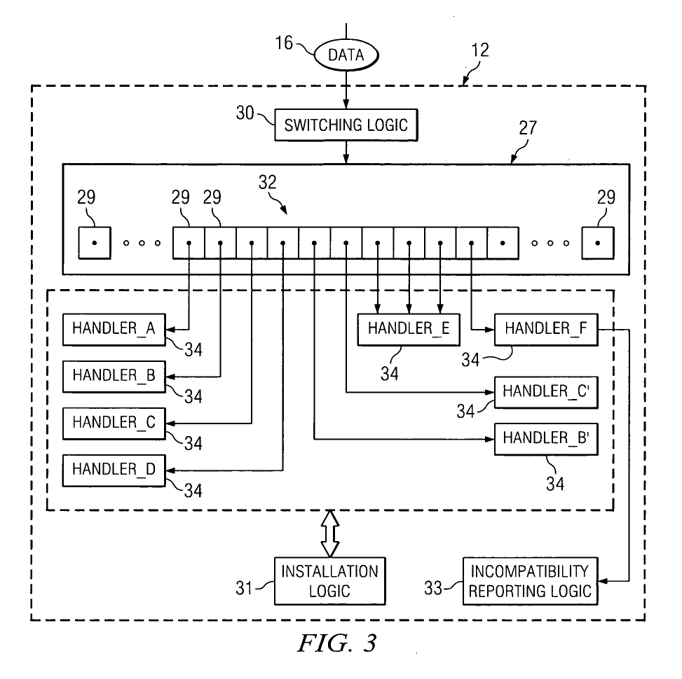

FIG. 2A shows a block diagram illustrating a field of data 16a formatted in accordance with a dialect of the present extensible versioning infrastructure. As illustrated, the data 16a starts with a header having a fixed size type-version identifier designated TYPE_VERSION_ID located in a type-version identifier field 18, followed by a field 20 for carrying a body of the data 16a. The type-version identifier is included within a header of the data 16a and all participating components 12 (FIG. 1A) should understand at least this part of the data 16a. Each type-version identifier has a value for identifying a type of request and a version. Other details of the request including functionalities, behavior, data format, the corresponding response, etc. are also defined according to the type-version identifier.

Once the value of a type-version identifier is associated with a request, the value is permanently recorded in an independent registry. Also, the recorded values should not be re-used for another request type. Thus, when a new version of a particular type of request is needed, a new value should be issued. In one embodiment, the independent registry can be as simple as a documentation contained in the centralized unit 11 (FIG. 1C).

If all available values of type-version identifiers are used up and further expansion is needed for identifying new versions, the present infrastructure allows for the use of a sub-type-version identifier. FIG. 2B shows a data field structure including: a type-version identifier field 18 for carrying a type-version identifier value; a sub-type-version identifier field 22 for carrying a sub-type-version identifier designated SUB_TYPE_VERSION_ID; and a body 24. In this embodiment, the size of the type-version identifier field 18 is 16-bits, and the largest value of the type-version identifier is 0×FFFF. In one embodiment, the largest value 0×FFFF is reserved to indicate the presence of a sub-type-version identifier located in the sub-type-version identifier field 22.

The field extension idea can be applied to further extend the type-version identifier on demand as shown in FIG. 2C. FIG. 2C shows a data field structure including: the type-version identifier field 18 for carrying a type-version identifier value; a sub-type-version identifier field 22 for carrying a sub-type-version identifier value; a sub-sub-type-version identifier field 26 for carrying a sub-sub-type-version identifier value designated SUB_SUB_TYPE_VERSION_ID; and a body 28. Assuming that the size of the sub-type-version identifier field 22 is 16-bits, the largest value of the sub-type-version identifier is 0×FFFF, and this value is reserved to indicate the presence of a sub-sub-type-version identifier in the field 26. In this way, the present extensible versioning infrastructure allows for the addition of a theoretically unlimited number of values for the type-version identifier. Such flexibility in extension removes unnecessary assumptions and constraints one has to make for the purpose of ensuring extensibility in existing versioning systems.

The sizes of the fields 18, 22, and 26 in FIG. 2C are determined considering the efficiency in manipulation and space as well as the prospective expansion of the type-version identifier. For example, on a 32-bit architecture, the size of each of the fields 18, 22, and 26 can be 32-bits. In a networked environment where 32 bytes is the maximum packet size, one would not want to use up more than one fourth of the available space, i.e., 64-bits, for passing the value of the type-version identifier. In most cases, 16 bits would be more than enough for most applications and this number is used in the following examples and figures for the purpose of illustration.

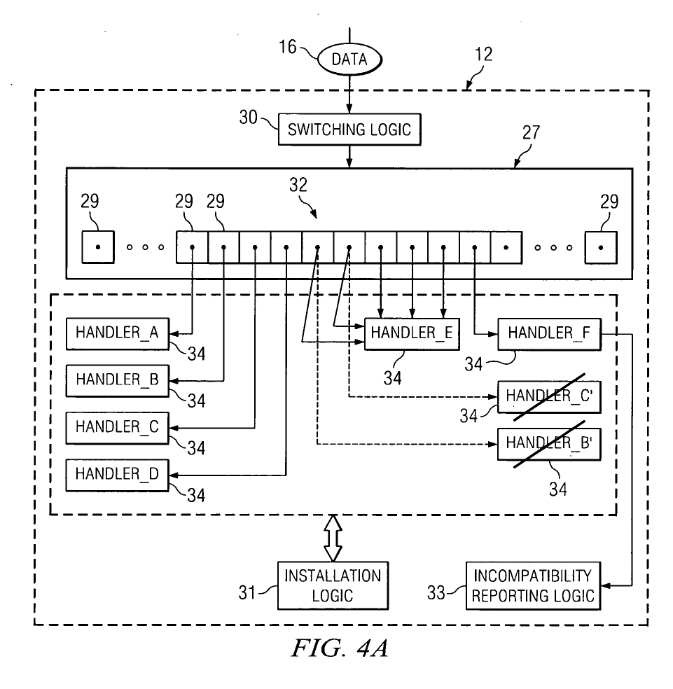

FIG. 3 shows a schematic block diagram illustrating further details of one of the components 12 (FIG. 1A) in accordance with one embodiment of the present extensible versioning infrastructure. The component 12 includes: a plurality of handlers 34, each being operative to process data formatted in accordance with one or more associated dialect versions supported by the handler; installation logic 31 for installing and de-installing handlers 34; switching logic 30 for processing incoming data 16; and a data structure 27 comprising a pointer array 32 that has a plurality of elements 29 forming a data structure for use in managing handlers, each element of the array 32 being a pointer and providing a call back function for a corresponding one of the handers 34. It should be noted that a version of a certain type of request indicated by the type-version identifier of an incoming data may not be one of the versions of the same certain type of request supported by installed handlers of a component. Such data is said to be incompatible with the component and would not be processed. For this reason, each component may include incompatibility reporting logic 33 for reporting the reception of incompatible type-version identifiers to a human operator.

The switching logic 30 provides a common handler, as it processes incoming data 16 received at the component 12. When the component receives the incoming data, the switching logic 30 indexes the pointer array 32 using a type-version identifier extracted from the received data to determine whether the component 12 has a handler that supports the type and version indicated by the type-version identifier 18 (FIG. 2A) of the data. Using the type-version identifier as an index, the switching logic selects an appropriate pointer 29 from the array 32. In this manner, the pointer array 32 is used to realize the sub data structure for managing handlers. A pointer 29 selected based on the received type-version identifier invokes a corresponding one of the handlers 34, which supports data of the type and version specified by the received type-version identifier.

The switching logic 30 is also responsible for processing unrecognized type-version identifiers.

In FIG. 3, the handlers designated HANDLER_B′ and HANDLER_C′ are new versions of original handlers designated HANDLER_B and HANDLER_C, respectively. For example, the original handler HANDLER_C supports requests of a certain type and a first version. In this case, the new handler HANDLER_C′ supports requests of the same certain type, but of a second (new) version. In systems using multiple versions of a dialect, a new handler should be written for each new version, although the new handler may share some common logic with an older handler. It is strongly advisable to avoid using the shared common logic employing a version checking process to differentiate between versions because, as mentioned in the Background section, the version checking process is error prone and tedious.

One of the handlers 34 in FIG. 3, the one designated HANDLER_E, is a handler for unsupported type-version identifiers. In accordance with the present extensible versioning infrastructure, HANDLER_E should be implemented with caution since unknown or unsupported type-version identifiers are not necessarily generated by an error. For example, the unknown or unsupported type-version identifiers might be associated with a new component introduced into the society of participating components and the new component talks in a dialect not understood by others. The reception of the unsupported type-version identifiers can be reported but care should be taken to avoid flooding of such reports.

As mentioned, an issued value of the type-version identifier is not removed from an independent registry even if the handler associated with the issued value is no longer in use (i.e., the handler becomes “obsolete”). Thus, the switching logic 30 of the component 12 can recognize incompatible type-version identifiers by referring to the independent registry. One of the handlers 34, the one designated HANDLER_F, is a special handler for incompatible type-version identifiers. HANDLER_F triggers an incompatibility reporting logic 33 that reports receipt of incompatible type-version identifiers to a human operator. The report can include information indicating sender of the incompatible type-version identifier to pinpoint immediately the source thereof.

The component 12 should ignore data specifying unexpected, unrecognized, or unknown type-version identifiers. Upon receiving such data, the component 12 may perform one or more of the following actions (or equivalent thereto): a) internally trace the sender of the data specifying unexpected, unrecognized, or unknown type-version identifiers employing a tracing facility in a preset period of time, preferably preventing a trace log from flooding, if the component has such tracing facility, b) reply to the sender with a control type-version identifier as will be explained below, and c) report the reception of the data specifying the unknown type-version identifier to a module, such as a standard console for a human operator. The choice of these actions depends on implementation. For example, one implementation can ignore all unrecognized type-version identifiers, and report the reception of the other unknown ones to a module.

Alternatively, the component 12 may report to a centralized unit 11 (FIG. 1C) that can translate the unrecognized type-version identifier instances into appropriate operator messages. These operator messages, for example, can make suggestions for improvement on the operational environment, or call for an operator's attention to unexpected behavior of components or inappropriate communication between components. An operator may enter policy programmatically in real time instructing the centralized unit 11 (FIG. 1C) to perform proper actions upon receiving such notification. For example, the centralized unit 11 (FIG. 1C) might be programmed by an operator to ignore the babbling of a specific type of incompatibility error coming from a certain node, once the operator has initiated a manual intervention for fixing such incompatibility problem.

As indicated in FIG. 3, the new handlers designated HANDLER_B′ and HANDLER_C′ can coexist with the original handlers designated HANDLER_B and HANDLER_C. In this case, the initialization routines for the original and new versions may be performed without assuming any knowledge regarding the presence or absence of the other versions. However, there are special cases when only one of the original and new versions can be supported at a time. For example, it is not uncommon to have different product releases for a daemon process wherein each release supports one version of a protocol. Thus, until the daemon process registers with kernel of a particular component, that component would not know which version the daemon process would support. The term kernel refers to an essential layer on which the operating system of the component rests. In such cases, the present extensible versioning infrastructure provides all versions and, upon registration of the daemon process, selects a hander corresponding to the version supported by the daemon process.

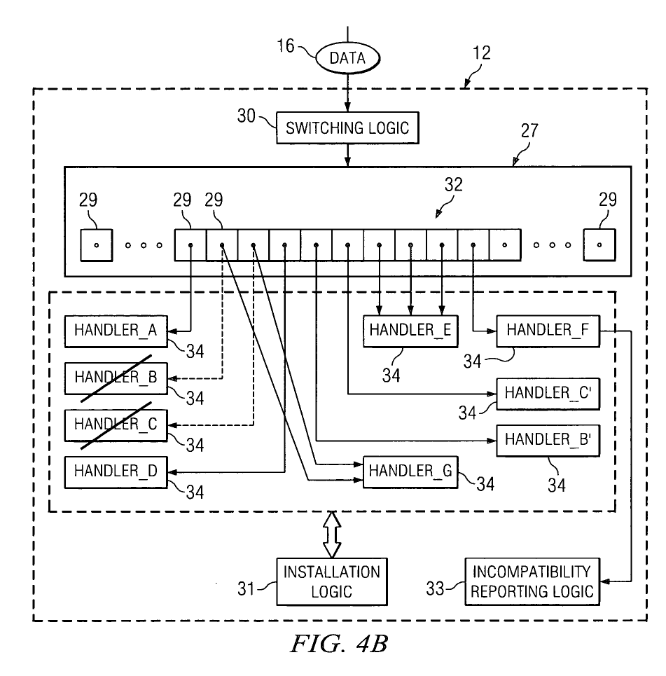

As mentioned, each component 12 (FIG. 3) may include the installation logic 31 for installing selected handlers, de-installing handlers conflicting with the selected handlers, and redirecting pointers 29 associated with the installed or de-installed handlers. FIGS. 4A and 4B show schematic block diagrams of elements illustrating how to manage conflicting handlers associated with various versions employing the installation logic 31.

As shown in FIG. 4A, assume that the component 12 has original handlers designated HANDLER_B and HANDLER_C that interfere with new handlers designated HANDLER_B′ and HANDLER_C′, respectively. FIG. 4A illustrates one possible configuration where HANDLER_B and HANDLER_C are installed and HANDLER_B′ and HANDLER_C′ are de-installed by the installation logic 31. The installation logic redirects the pointers 29 associated with HANDLER_B′ and HANDLER_C′, and notifies the switching logic 30 that HANDLER_B′ and HANDLER_C′ have been de-installed.

FIG. 4B shows another configuration where the installation logic 31 installs the handlers 34 designated HANDLER_B′, HANDLER_C′ and HANDLER_G and de-installs the handlers 34 designated HANDLER_B and HANDLER_C. In the depicted embodiment, the pointers 29 associated with HANDLER_B and HANDLER_C (as indicated by dashed lines) are redirected to point to one of the handlers 34 designated HANDLER_G. Again, the installation logic 31 redirects pointers associated with HANDLER_B and HANDLER_C to HANDLER_G, and notifies the switching logic 30 that HANDLER_B and HANDLER_C have been de-installed.

As mentioned, each value of the type-version identifier can be assigned to an associated version of an associated type of request. Thus, a protocol or interface designer can assign any value to a version of a type of request. However, to enhance the efficiency of the present extensible versioning infrastructure, some values are reserved for control requests while others are assigned to non-control requests. Hereinafter, the term “control type-version identifier” refers to a type-version identifier whose value is one of the reserved values and associated with specific control information. Control requests are handled by the switching logic 30 (FIG. 3).

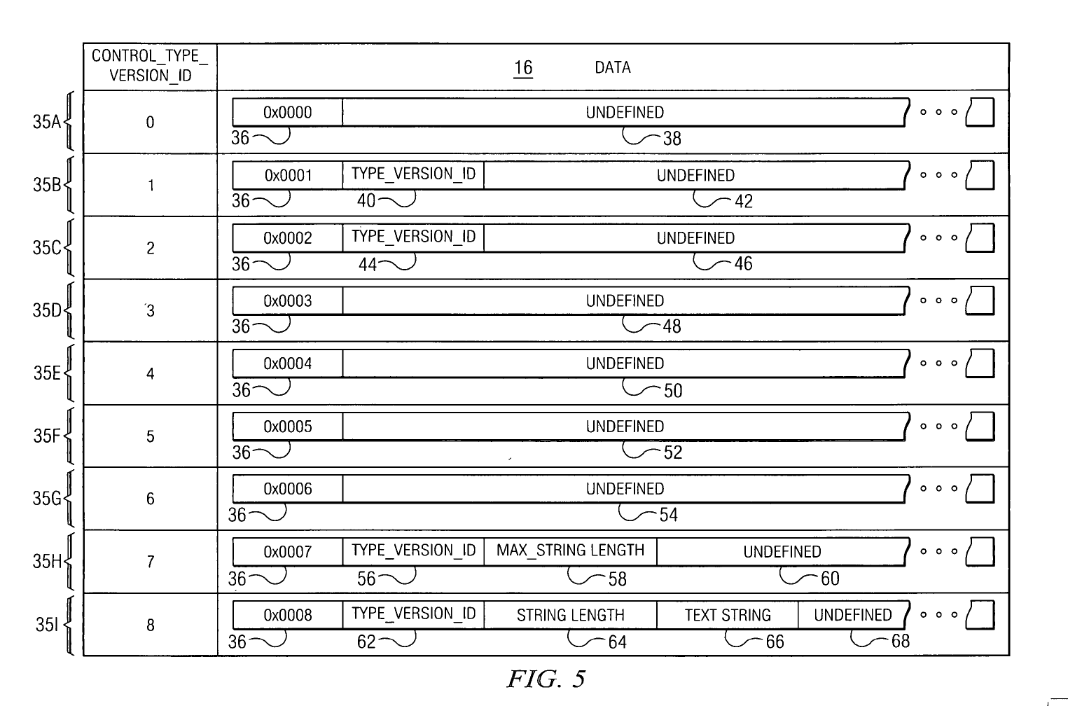

FIG. 5 shows a tabulated block diagram illustrating data field structures of a plurality of different control requests 35 used in accordance with an extensible versioning infrastructure according to one embodiment. As each of the control requests 35 is a type of data 16 (FIGS. 2A-2C), the components 12 (FIG. 1A) are expected to process the control requests 35 depicted in FIG. 5.

A first column of the table in FIG. 5 designated CONTROL_TYPE_VERSION_ID provides a list of values of control type-version identifiers, and a second column shows data structures of different types of control requests. As indicated, each of the control requests 35 includes a header 36, and a body. Each of the header fields 36 contains a control type-version identifier value. In the depicted embodiment, a control type-version identifier value of “0” (or, equivalently 0×0000) indicates that a control request 35A is a request that should be dropped silently by a component that receives it (i.e., a receiver component). As indicated in FIG. 5, a control type-version identifier value of “0” indicates that the entire field 38 of the body is undefined, which means there is no data associated with this control request.

As described above with reference to FIGS. 4A and 4B, some of the components 12 (FIG. 1A) may not support certain types and versions of requests, at least temporarily. As explained further below, each of the components 12 (FIG. 1A) may be operative to track the capabilities of other components in terms of which types and versions of requests each component supports.

Referring again to FIG. 5, a control type-version identifier value of “1” (or, equivalently 0×0001) appearing in the header field 36 indicates that the request is a “stop sending request” 35B. The stop sending request 35B carries a type-version identifier in a type-version identifier field 40, followed by an undefined field 42. The request 35B may be sent by one of the components (hereinafter referred to as a “notifying component”) to another one of the components (hereinafter referred to as a “receiving component”) to indicate that the receiving component may stop sending a specified type and version of data (or request) to the notifying component. More specifically, one of the handlers 34 (FIG. 3), the one designated HANDLER_E, of the notifying component sends the stop sending request 35B to the receiving component. The type-version identifier field 40 of the request 35B carries a type-version identifier indicating a type and version of request that the receiving component may stop sending to the notifying component. A component receiving the stop sending request 35B may ignore the request or respond by storing information in the data structure 27 (FIG. 3) to indicate that the recipient component should not attempt to deliver requests of the type and version specified by the type-version identifier in the field 40 to the notifying component in the future unless otherwise notified. A component sending a stop sending request 35B should not expect the receiving component to efficiently turn off sending the specified type and version of request, even though the receiving component should attempt not to send requests of the specified type-version. Also, if a protocol is stateless, the receiving component may respond to the stop sending request 35B by ceasing to send requests of the specified type and version.

As further shown in FIG. 5, a “start sending” request 35C is identified by a control type-version identifier value of “2” (or, equivalently 0×0002) in its header field 36, and carries a value of type-version identifier in a field 44 followed by an undefined field 46. Upon receiving the start sending request 35C, the receiving component may store information to indicate that the receiving component may send, until otherwise notified, requests of the specified type and version in the field 44. The sender of the start sending request 35C (i.e., the notifying component) may retry sending this request in case the notifying component believes that the receiving component has not yet recognized that the receiving component may start sending requests of the specified type and version specified in the field 44. For practical purposes and for completeness, the start sending request 35C is provided. This request is provided, because the elements of data structure 27 (FIG. 3) of each component 12 (FIG. 3) associated with requests supported by the component are set to “enabled” (or, equivalently, turned on) during the establishment of connection with other components 12. Typically, once a particular request type is determined to be compatible, it is seldom later determined to be compatible once again. Namely, it is seldom checked again. Also, the control requests 35A, 35B, and 35C cannot be turned on/off, i.e., they should not appear in the fields 40 and 44. If they are listed, they should be ignored and dropped silently.

As the control requests 35A and 35B are idempotent and can dynamically turn on/off sending further requests, they can be used to control the volume of request traffic between components and keep the request traffic minimal, which is one of the advantages of the present extensible versioning infrastructure.

Still referring to FIG. 5, a “limited stop sending” request 35D is identified by a control type-version identifier value of “3” (or, equivalently 0×0003) in its header field 36, and indicates that a component receiving the request 35D should stop sending all requests except the control requests 35A, 35B, and 35C to a notifying component. As illustrated in FIG. 5, the limited stop sending request 35D indicates that the entire field 48 is undefined, which means there is no data associated with this control request.

A “start sending all” request 35E is identified by a control type-version identifier value of “4” (or, equivalently 0×0004 ) in its header field 36, and indicates that a component receiving the request 35E may start sending all requests including the control requests 35A, 35B, and 35C to a notifying component.

A “test connection” request 35F and a “test connection” response 35G are identified by control type-version identifier values of “5” and “6” in the header fields 36, respectively. The test connection request 35F indicates that a component receiving the request 35F should reply with the test connection response 35G to a notifying component. The request 35F and response 35G are used to check the status of connection between two components. For example, an underlying connection between two components might have failed due to transient errors. To probe the status of the underlying connection, a notifying component may keep on sending the test connection request 35F periodically until a receiving component replies with the test connection response 35G. The request 35F and the response 35G have undefined fields 52 and 54, respectively.

A “message reporting” request 35H is characterized by a control type-version identifier value of “7” in its header field 36, and may be sent by a notifying component that has received a request it does not recognize. As illustrated in FIG. 5, the message reporting request 35H further includes: a type-version identifier field 56 carrying a type-version identifier value indicating the unrecognized request; a string size field 58 carrying a number designated MAX_STRING_LENGTH that indicates the maximum length of a message to be contained in a response that is expected from the recipient of the message reporting request 35H (i.e., the original sender); and an undefined field 60. A component receiving request 35H, typically the original sender of the unrecognized request specified in the type-version identifier field 56, may reply with a “message reporting” response 35I characterized by a control type-version identifier value of “8” in the header field 36. The message reporting response 35I further includes: a type-version identifier field 62 carrying a type-version identifier value indicating the unrecognized request; a string length field 64 carrying a value designated STRING_LENGTH indicating the length of message contained in a following message field 66; and an undefined field 68. The message designated TEXT_STRING is a description of the unrecognized request specified in the field 62. If the unrecognized type-version identifier specified in the field 62 cannot be identified (e.g., due to software bug), the value carried in the string length field 64 is “0” and the message contained in the message field 66 is a null string.

In one embodiment, the message TEXT_STRING is an ASCII text string and, thus, can be reported to a human operator without further interpretation. Also, TEXT_STRING can be saved in a table so that a component receiving the same unrecognized requests can report the same TEXT_STRING to the human operator by referring to the table without sending the message reporting request 35H repeatedly to the original sender of the unrecognized request In addition, the format of the text strings can be standardized.

FIG. 5 shows examples of control type-version identifiers and does not restrict the format of control requests. Those of ordinary skill in the art will appreciate that other formats can be used as long as the functionalities of the control requests 35 depicted in FIG. 5 are fulfilled. The control requests 35 illustrated in FIG. 5 can be used to control 16-bit-respresentable number of non-control requests. If a type-version identifier is extended as illustrated in FIGS. 2B and 2C, the existing control requests would not be sufficient for controlling the extended non-control requests. In such case, a new control type-version identifier and corresponding control requests should be defined. Practically, a 16-bit field is sufficient to represent all types and versions of requests.

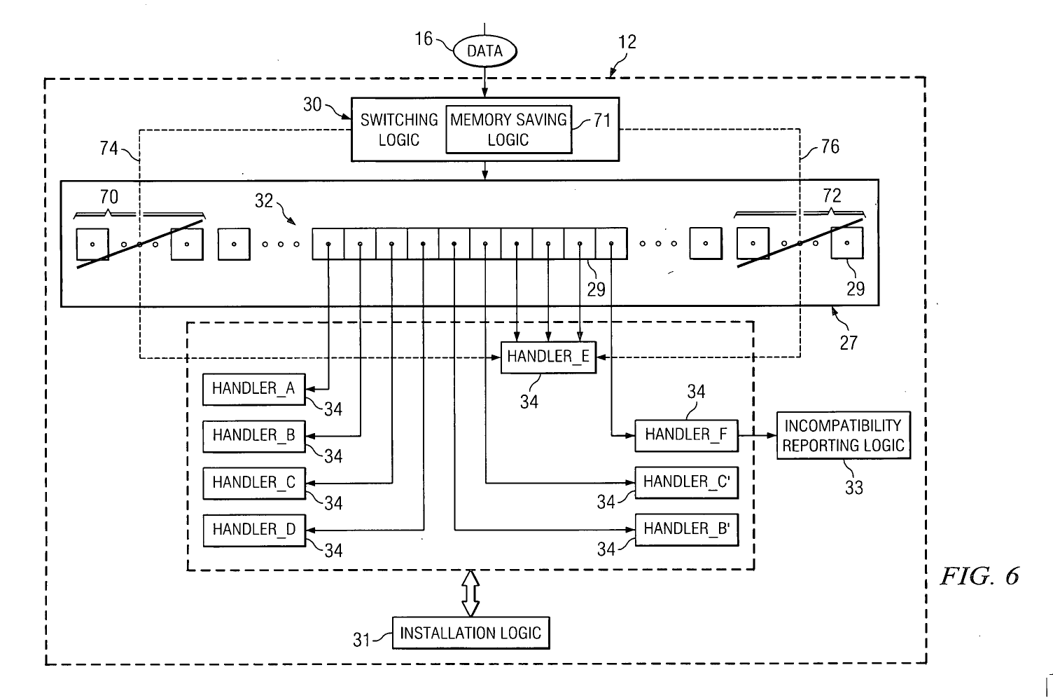

FIG. 6 shows a schematic block diagram illustrating details of one of the components 12 (FIG. 1A) in accordance with an alternative embodiment of the present extensible versioning infrastructure. As illustrated in FIG. 6, the component 12 of the alternative embodiment includes all of the same elements as the embodiment shown in FIG. 3 except that, in this alternative embodiment, the switching logic 30 includes memory saving logic 71 that reduces the amount of memory needed for the pointer array 32.

When there is a large number of valid type-version identifier values in use, reserving pointers 29 for all valid type-version identifier values would require an appreciable amount of memory. To reduce the required amount of pointer memory, the component may include the memory saving logic 71 including two delimiting variables; a min-type-version and a max-type-version. The min-type-version (or max-type-version) defines the lower (or upper) bound of type-version identifier values, wherein each type-version identifier value larger than the min-type-value and smaller than the max-type-version is associated with one of the pointers 29 that points to the corresponding one of the handlers 34.

In FIG. 6, sub-groups 70 and 72 of the pointers 29 are associated with the type-version identifier values that are smaller than the min-type-version value and larger than the max-type-version value, respectively. The sub-groups 70 and 72 of the pointers can be removed to reduce the amount of pointer memory, as depicted in FIG. 6. For example, upon receiving a request that has a type-version identifier value associated with the sub-group 70, the switching logic 30 invokes directly one of the handlers 34 designated HANDLER_E as depicted by a broken line 74 In FIG. 6, HANDLER_E represents a handler for processing unsupported requests.

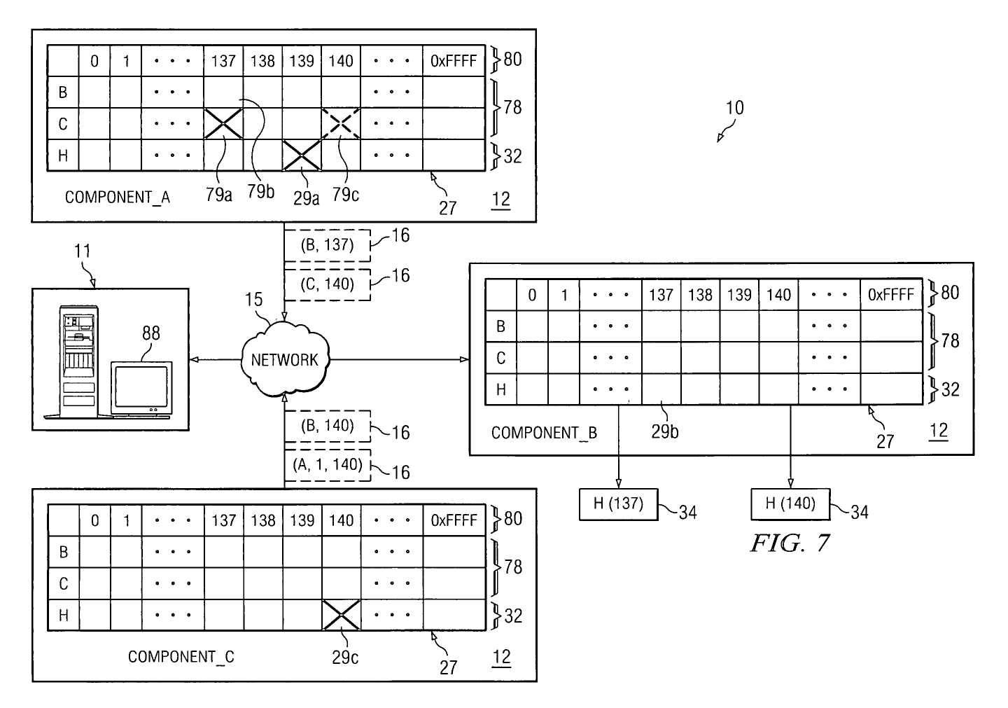

FIG. 7 shows a block diagram illustrating an embodiment of the system 10″ of FIG. 1C, wherein each of the data structures 27 of each of the components 12 further includes a send flag array 78 having a plurality of flag elements 79. Numerical values 80 listed in columns of the data structure 27 represent the values of type-version identifiers. In one embodiment, the numerical values 80 range from 0 to 0×FFFF.

Each flag element 79 of the send flag array 78 corresponds to one of the components 12 (other than the component at which the flag element resides) and also to a type and version of request. Each element 79 indicates whether or not its resident component may send requests of the corresponding type and version to the component. For example, a matrix element 79a of the data structure 27 at COMPONENT_A indicates that COMPONENT_A should not send the requests of the type and version indicated by a type-version identifier having value of “137” to COMPONENT_C.

As described above, the data structure 27 also contains the pointer array 32 (FIG. 3), wherein each pointer 29 of the array 32 points to a corresponding one of the handlers 34 (FIG. 3). The numerical value 80 corresponding with each pointer 29 specifies the value of a type-version identifier indicating the type and version supported by a corresponding handler. In FIG. 7, the pointer 29a is marked “x” to indicate that COMPONENT_A has de-installed a handler indicated by the pointer 29a.

Some of the data 16 exchanged by the components 12 are non-control requests. For example, each of the data 16 designated (B, 137), (B, 140), and (C, 140) is a non-control request. The character and number appearing in the designation of each non-control request indicate a destination and a type-version identifier value carried in the type-version identifier field 18 (FIGS. 2A-C) of the request, respectively. For example, the designation (B, 137) indicates that the corresponding non-control request is being sent to COMPONENT_B and that the data is of a type and version indicated by a type-version identifier having a value of “137.”

A request designated (A, 1, 140) is one of the control requests 35 (FIG. 5), wherein a character, a first number, and a second number appearing in the designation of the control request indicate the destination of the data, the value of CONTROL_TYPE_VERSION_ID (FIG. 5), and the type-version identifier value specified in the type-version identifier field 40 (FIG. 5), respectively. For example, the designation (A, 1, 140) indicates that the corresponding data is a stop sending request 35B (FIG. 3) indicated by the CONTROL_TYPE_VERSION_ID having a value “1”, being sent to COMPONENT_A, and that COMPONENT_A may stop sending requests of a type and version indicated by a type-version identifier having a value of “140” to the sender of the request (A, 1, 140).

As the send flag array 78 is a per-connection data structure, the information stored in the send flag array 78 is cleared upon establishing a connection between communicating components. Some of the flag elements 29 of the send flag array 78 associated with unsupported type-version requests are set to “disabled” while the others are set to “enabled.” Also, the send flag array 78 might be consolidated according to how the underlying network protocols are implemented and how the control requests 35 (FIG. 5) are defined. For example, if only one control request is used to control sending all of the requests from one component to another, all of the elements 79 of the send flag array 78 might be consolidated into a 1 bit element.

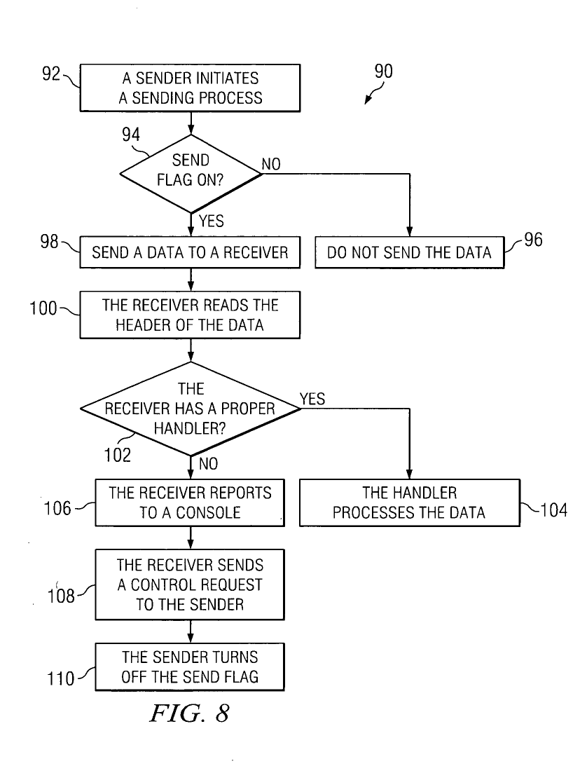

FIG. 8 shows a flowchart depicting a versioning control process at 90 for governing the exchange of data of different types and versions between the components of the system of FIG. 7. The process begins with a step 92 in which a sender (one of the components 12 of FIG. 7) initiates a sending process for sending data of a particular type and version to an intended receiver (another one of the components 12 of FIG. 7). From step 92, the process proceeds to 94 at which the switching logic 30 (FIG. 3) of the sender indexes the flag array 78 (FIG. 7) at the sender to determine whether or not the sender may send requests of the particular type and version to the intended receiver. The determination at 94 includes determining whether the send flag element 79 (FIG. 7) corresponding with the particular type and version and the intended receiver is “on.” If it is determined at 94 that the sender cannot send requests of the particular type and version to the intended receiver (e.g., because the sender previously received a stop sending control request 35B from the intended receiver indicating the particular type and version), then the process proceeds to step 96 in which the sending process is terminated without sending the data. Otherwise, the process proceeds to step 98 in which the sender sends the data of the particular type and version to the receiver.

In step 100, the receiver receives the data from the sender, and reads the header of the data including a type-version identifier identifying the particular type and version of data received from the sender. From step 100, the process proceeds to 102 at which the switching logic 30 (FIG. 3) of the receiver uses the received type-version identifier to index the pointer array 32 (FIG. 3) at the receiver to determine whether the receiver has a proper handler that supports data of the particular type and version of the received data. If it is determined at 102 that the receiver has a proper handler, the switching logic at the receiver invokes the proper handler and process the received data. However, if it is determined that the receiver does not have a proper handler, the receiver cannot process the data. In this case, the receiver may take steps to report to a system administrator and also to the sender that the receiver is not currently capable of handling data of the particular type and version.

After determining at 102 that the receiver does not have a proper handler for the particular type and version of data received, the process proceeds to step 106 in which the receiver reports to a system administrator via a console that the receiver has received data of the particular type and version, and that it does not have a proper handler to support this data. In step 108, the receiver sends a control request (e.g., a stop sending control request 35B shown in FIG. 5) back to the sender to indicate that the sender should stop sending data of the particular type and version to the receiver. In response to receiving a stop sending control request 35B (FIG. 5), the sender may update its send flag array 78 (FIG. 7) to indicate that the sender should stop sending data of the particular type and version to the receiver.

Referring back to FIG. 7, several examples of processing according to the process 90 (FIG. 8) are illustrated. In a first example, COMPONENT_A initiates a sending process (see step 92 in FIG. 8) to send data designated (B, 137) of a type and version identified as ‘137” to COMPONENT_B. COMPONENT_A refers to its send flag array 78 to determine if a flag element 79b corresponding to the data (B, 137) is turned on. As indicated, the send flag element 79b is not marked, and therefore COMPONENT_A sends the data (B, 137) to COMPONENT_B. COMPONENT_B receives the data (B, 137), and its switching logic 30 (FIG. 3) uses the type-version identifier value carried in the header of the data (B, 137) to index its resident pointer array 32 to determine if COMPONENT_B has a handler that supports requests of the type and version indicated by the value “137” (see steps 100 and 102 of FIG. 8). The pointer 29b corresponding to the data (B, 137) is not marked “x”, which means COMPONENT_B has installed a supporting handler 34 (i.e., the one designated H(137)). Therefore, a handler specified by the pointer 29b, H(137), processes the data (B, 137).

In a second example, COMPONENT_C sends the data designated (B, 140) to COMPONENT_B which processes the data (B,140) using one of the handlers 34; the one designated H(140). Here, the handlers H(137) and H(140) can be handlers that support two different versions of a type of request.

In a third example, COMPONENT_A initiates a sending process (see step 92 in FIG. 8) to send the data designated (C, 140). COMPONENT_A refers to its send flag array 78 to check if a flag element 79c corresponding to the data designated (C, 140) is turned on. Assuming that a send flag 79c is not marked at this stage, COMPONENT_A sends the data (C, 140) to COMPONENT_C. COMPONENT_C receives the data (C, 140), and its switching logic 30 (FIG. 3) uses the type-version identifier value carried in the header of the data (C, 140) to index its resident array 32 (FIG. 3) to determine if COMPONENT_C has a handler that supports the specified type and version indicated by the value “140.” The pointer 29c corresponding to the data (C, 140) is marked “x”, which means COMPONENT_C does not have a proper handler. In this case, COMPONENT_C reports to a system administrator via a console 88 (FIG. 7) that COMPONENT_C has received the data (C, 140) and does not have a proper handler to support the data (C, 140). Therefore, COMPONENT_C sends a control request (A, 1, 140) back to COMPONENT_A to indicate that COMPONENT_A should stop sending data of the type and version identified by “140.” In response to receiving the data (A, 1, 140), COMPONENT_A updates its send flag array 78 (FIG. 7) to indicate that COMPONENT_A should stop sending data of the type and version identified by “140” to COMPONENT_C.

In another example, COMPONENT_A initiates a process to send the data designated (C, 137) to COMPONENT_C. COMPONENT_A checks if the flag element 79a corresponding to the data (C, 137) is turned on. As indicated in FIG. 7, the send flag 79a is marked, and therefore the sending process is terminated without sending data.

The present extensible versioning infrastructure is not concerned with security. In a non-trusted environment, security is enforced by a carrier protocol that encrypts data 16 (FIGS. 2A-2C) at a sending node, routes the encrypted data through the medium and decrypts the data before forwarding it to the switching logic 30 (FIG. 3) of a receiving component 12 (FIG. 3). As the data 16 forwarded to the switching logic 30 has already passed the security check performed by the carrier protocol, the present extensible versioning infrastructure is not concerned with security in a non-trusted environment. In a trusted environment, each participating component is, by definition, not concerned with security.

Although the present extensible versioning method and infrastructure have been described in accordance with the embodiments shown, variations to the embodiments would be apparent to those skilled in the art and those variations would be within the scope and spirit of the present extensible versioning infrastructure. Accordingly, it is intended that the specification and embodiments shown be considered as exemplary only, with a true scope of the infrastructure being indicated by the following claims and equivalents.

1. A method for minimizing compatibility issues among interacting components of different dialect versions, comprising:
defining a plurality of type-version identifiers each indicating a corresponding type and version from among a plurality of types and versions of requests;
installing at least one handler at each of a first component and a second component, each of said handlers supporting a corresponding one of said plurality of types and versions of requests;
sending a request from the first component to the second component, said sent request having a particular identifier that is one of the plurality of type-version identifiers indicating a particular type and version of said sent request; and
causing said second component to,
extract said particular identifier of said sent request,
use said particular identifier to determine whether one of said handlers installed at said second component properly supports said particular type and version of said sent request, and
if a proper one of said installed handlers supports said particular type and version of said sent request, using said proper handler to process said sent request.

2. A method as recited in claim 1, further comprising:
providing said first component with a first data structure for indicating whether or not said first component may send requests of said particular type and version to said second component; and
before said step of sending a request, accessing said first data structure to determine whether requests of said particular type and version may be sent to said second component.

3. A method as recited in claim 2, further comprising:
reserving at least one of said plurality of type-version identifiers for indicating a stop sending control request, said stop sending control request having a first field carrying said reserved type-version identifier, and a second field carrying a second one of the plurality of type-version identifiers; and
if none of said installed handlers at said second component properly supports said particular type and version of said sent request, causing said second component to send a stop sending control request to said first component to indicate that said first component should stop sending requests of said particular type and version to said second component.

4. A method as recited in claim 3, further comprising:
receiving said stop sending control request at said first component; and
updating said first data structure to indicate that said first component may not send requests of said particular type and version to said second component.

5. A method as recited in claim 1, wherein said sent request carries said particular identifier in a header field, the method further comprising:
extending said particular identifier by defining a sub-type-version identifier in said header field, said particular identifier having a value that indicates the presence of said sub-type-version identifier in said header field.

6. A method as recited in claim 5, the method further comprising:
extending said sub-type-version identifier by defining a sub-sub-type-version identifier in said header field, said sub-type-version identifier having a value that indicates the presence of said sub-sub-type-version identifier in said header field.

7. A method as recited in claim 1, wherein said step of using said particular identifier to determine whether one of said handlers installed at said second component properly supports said particular type and version of said sent request further comprises:
using said particular identifier to index a second data structure having a plurality of pointers, each said pointer being associated with one of said plurality of type-version identifiers and pointing to a corresponding one of said handlers installed at said second component.

8. A method as recited in claim 7, further comprising:
installing an unsupported-type-version handler at said second component, said unsupported-type-version handler supporting requests carrying any one of a plurality of unsupported ones of said type-version identifiers wherein said sent request carries one of said unsupported type-version identifiers; and
invoking said unsupported-type-version handler in response to said received unsupported type-version identifier without indexing said second data structure;
whereby said second data structure need not store pointers for each of said unsupported type-version identifiers.

9. A versioning infrastructure for minimizing compatibility issues among interacting components of different dialect versions, comprising:
a plurality of components between which requests may be exchanged, each request being of a type and version from among a plurality of types and versions and having a header carrying a type-version identifier indicating a corresponding type and version of said request; and
each said component including,
an input port for receiving one of said requests,
at least one handler supporting requests of a corresponding one of the plurality of types and versions,
a pointer array having a plurality of elements each being a pointer to a corresponding one of said handlers, and
switching logic operable to
extract said type-version identifier carried by said received request,
use said extracted type-version identifier to index said pointer array to determine a selected one of said handlers, and
invoke said selected handler.

10. A versioning infrastructure as recited in claim 9, wherein each said component further includes installation logic operable to install said handlers at said component.

11. A versioning infrastructure as recited in claim 9, wherein each said component further includes a flag array having at least one flag element corresponding to an intended receiver component and to a particular one of the plurality of types and versions, each said flag element indicating whether or not said component may send requests of said corresponding particular type and version to said corresponding intended receiver component.

12. A versioning infrastructure as recited in claim 9, wherein each said component further includes incompatibility reporting logic operable to report receipt of a request that is not supported by any one of said installed handlers.

13. A versioning infrastructure as recited in claim 9, wherein said requests include at least one control request for managing versioning in accordance with the infrastructure, each said control request carrying a corresponding control type-version identifier specifying a type of control request, said control requests including a stop sending control request to be sent by a notifying one of the components to a receiving one of the components to indicate that said receiving component should stop sending requests of a particular one of the plurality of types and versions to said notifying component.

14. A versioning infrastructure as recited in claim 13, wherein said control requests further include a start sending control request to be sent by a notifying one of the components to a receiving one of the components to indicate that said receiving component may start sending requests of a particular one of the plurality of types and versions to said notifying component.

15. A versioning infrastructure as recited in claim 13, wherein said control requests further include a test connection request to be sent by a notifying one of the components to a receiving one of the components to indicate that said receiving component may send a test connection response to said notifying component so as to probe an underlying connection between said notifying component and said receiving component.

16. A versioning infrastructure as recited in claim 13, wherein said control requests further include a message reporting request to be sent by a notifying one of the components that has received an unrecognized request to a receiving one of the components to indicate that said receiving component may send a message reporting response that has a message describing said unrecognized request to said notifying component.

17. A versioning infrastructure as recited in claim 9, wherein said header of each said request carries a sub-type-version identifier for extending said type-version identifier, said type-version identifier having a value that indicates the presence of said sub-type-version identifier.

18. A versioning infrastructure as recited in claim 17, wherein said header of each said request carries a sub-sub-type-version identifier for extending said sub-type-version identifier, said sub-type-version identifier having a value that indicates the presence of said sub-sub-type-version identifier.

19. A versioning infrastructure as recited in claim 9, wherein
one of said handlers is an unsupported-type-version handler, said unsupported-type-version handler supporting requests carrying any one of a plurality of unsupported ones of said type-version identifiers; and
said switching logic includes memory saving logic that invokes said unsupported-type-version handler in response to one of said unsupported-type-version identifiers carried by said received request without indexing said pointer array;
whereby said pointer array need not store pointers for each of said unsupported type-version identifiers.

20. A versioning infrastructure for minimizing compatibility issues among interacting components of different dialect versions, comprising:
a plurality of components between which requests may be exchanged, each request being of a type and version from among a plurality of types and versions and having a header carrying a type-version identifier indicating a corresponding type and version of said request; and
each said component including,
means for receiving one of said requests,
means for installing at least one handler at said component, each said handler supporting a corresponding one of the plurality of types and versions,
data structure means having a plurality of elements each being a pointer to a corresponding one of said handlers,
means for extracting said type-version identifier carried by said received request,
means for using said extracted type-version identifier to index said data structure means to determine a selected one of said handlers, and
means for invoking said selected handler.

21. Computer readable medium embodying program code with instructions for minimizing compatibility issues among interacting components of different dialect versions, comprising:
program code to cause a computer to define a plurality of type-version identifiers each indicating a corresponding type and version from among a plurality of types and versions of requests;
program code to cause a computer to install at least one handler at each of a first component and a second component, each of said handlers supporting a corresponding one of said plurality of types and versions of requests;
program code to cause a computer to send a request from the first component to the second component, said sent request having a particular identifier that is one of the plurality of type-version identifiers indicating a particular type and version of said sent request: and
program code to cause a computer having the said second component to:
extract said particular identifier of said sent request,
use said particular identifier to determine whether one of said handlers installed at said second component properly supports said particular type and version of said sent request,
if a proper one of said installed handlers supports said particular type and version of said sent request, using said proper handler to process said sent request.

22. A version identifier as recited in any of claims 1, 9, 20, or 21, wherein the dialect is a protocol.

23. A version identifier as recited in any of claims 1, 9, 20, or 21, wherein the dialect is an interface.

24. A communication network including a versioning infrastructure for minimizing compatibility issues among interacting components of different dialect versions, comprising:
a plurality of components located at nodes of said network and between which requests may be exchanged formatted according to a dialect implemented by a network protocol, each request being of a type and version from among a plurality of types and versions and having a header carrying a type-version identifier indicating a corresponding type and version of said request; and
each said component including,
an input port for receiving one of said requests,
at least one handler supporting requests of a corresponding one of the plurality of types and versions,
a pointer array having a plurality of elements each being a pointer to a corresponding one of said handlers, and
switching logic operable to extract said type-version identifier carried by said received request, and use said extracted type-version identifier to index said pointer array to determine and invoke a selected one of said handlers.
